(19) United States
(12) Patent Application Publication
(10) Pub. No.: US 2008/0092360 A1
(43) Pub. Date: Apr. 24, 2008

(54) THIN SEMICONDUCTOR CHIP PICKUP APPARATUS AND METHOD

(75) Inventors: Teak-Hoon LEE, Gyeonggi-do (KR); Myung-Kee CHUNG, Chungcheongnam-do (KR)

Correspondence Address: MARGER JOHNSON & MCCOLLOM, P.C., 210 SW MORRISON STREET, SUITE 400, PORTLAND, OR, 97204, US

(73) Assignee: SAMSUNG ELECTRONICS CO., LTD., Gyeonggi-do (KR)

(21) Appl. No.: 11/864,452

(22) Filed: Sep. 28, 2007

(30) Foreign Application Priority Data
Oct. 24, 2006 (KR) 2006-0103672

(51) Int. Cl. B23P 19/00

(52) U.S. Cl. 29/426.1; 29/762

(57) ABSTRACT

Provided are a thin semiconductor chip pickup apparatus and method for detaching a die bonding film from a semiconductor chip using the apparatus. The apparatus may include a stage for supporting a die-bonding film to which a semiconductor chip is attached, a plurality of suction members arranged on the center of the stage for extracting the die-bonding film by a vacuum, where the suction members detach the die-bonding film away from the semiconductor chip to form a vacuum region, and a plurality of vacuum suction ports respectively interposed between adjacent suction members to allow the suction members to detach the die-bonding film by the vacuum.

### CROSS-REFERENCE TO RELATED PATENT APPLICATION

This application claims the benefit of Korean Patent Application No. 10-2006-0103672, filed on Oct. 24, 2006, in the Korean Intellectual Property Office, the disclosure of which is incorporated herein by reference.

### BACKGROUND

1. Field of the Invention

The present invention relates to a semiconductor chip pickup apparatus, and more particularly, to a semiconductor chip pickup apparatus, which can separate a thin semiconductor chip from a die-bonding film without applying stress to the semiconductor chip, and method of picking up the thin semiconductor chip using the apparatus.

2. Description of the Related Art

Conventionally, the fabrication of semiconductor devices includes forming a plurality of semiconductor chips on a semiconductor wafer through a semiconductor manufacturing process, dividing the semiconductor wafers into individual semiconductor chips through a dicing process, and packaging the individual semiconductor chips. The dicing process includes attaching a die-bonding film to the semiconductor wafer, dicing the semiconductor wafer into individual semiconductor chips, and separating the individual semiconductor chips from the die-bonding film using a pickup apparatus.

Due to the downsizing of portable electronic devices, semiconductor packages are becoming smaller, thinner, and more light-weight; thus, semiconductor chips are also being fabricated to be thinner. As the semiconductor chips are becoming thinner, the influence of stress on the semiconductor chips during the dicing process has become more serious. Therefore, it is necessary to develop a semiconductor chip pickup apparatus that minimizes the stress that is applied to the semiconductor chips during the dicing process. Conventional pickup apparatuses that function to separate the semiconductor chips from the die-bonding film include a needle-type pickup apparatus, a pyramidal-type pickup apparatus, and a slide-type pickup apparatus.

FIG. 1 illustrates a conventional needle-type pickup apparatus. Referring to FIG. 1, a die-bonding film 13 is attached to a semiconductor chip 11 and laid on a vacuum wafer chuck 17. A plurality of plunger pins 15 corresponding to the semiconductor chip 11 are supported by a plunger 14 and disposed in the vacuum wafer chuck 17. Each of the plunger pins 15 has a keen front tip. The plunger 14 and the plunger pins 15 are elevated by a cylinder (not shown) in order to push up the semiconductor chip 11. Thus, the semiconductor chip 11 is extracted by a vacuum using a collet 18 and a transfer head 19, and is mounted on a lead frame or printed circuit board (PCB).

However, in the case of the conventional needle-type pickup apparatus 10, since the keen front tip of the plunger pin 15 penetrates the die-bonding film 13 and pushes up the semiconductor chip 11, stress is applied to the semiconductor chip 11. As a result of this stress cracks may be generated in the semiconductor chip 11 or corners of the semiconductor chip 11 may be broken. As semiconductor chips become thinner, the semiconductor chips become more sensitive to the stress. Therefore, the conventional needle-type pickup apparatus 10 is not suitable for separating a thin semiconductor chip from a die-bonding film. Also, as illustrated in FIG. 2, when the semiconductor chip 11 is separated from the die-bonding film 13, a remnant 13a of the die-bonding film 13 is left in a corner 11a of the semiconductor chip 11.

The pyramidal-type pickup apparatus includes a plurality of annular connection members such that a semiconductor chip is separated from a die-bonding film by stages; namely, from an outer circumferential portion of the semiconductor chip toward a central portion of the semiconductor chip. In the pyramidal-type pickup apparatus, the annular connection members are sequentially raised from an outer connection member to a central connection member to form a pyramidal shape, so that the semiconductor chip can be separated from the die-bonding film. Like the conventional needle-type pickup apparatus 10, in the pyramidal-type pickup apparatus, the annular connection members that are raised in a pyramid shape apply stress to the semiconductor chip resulting in the possibility that the semiconductor chip may be cracked or damaged. For this reason, it is also difficult to apply the pyramidal-type pickup apparatus for the separation of a thin semiconductor chip from a die-bonding film.

The slide-type pickup apparatus includes a slide that moves from side to side and extracts a semiconductor chip by a vacuum so that the semiconductor chip is separated from a die-bonding film. Since the slide forms a vacuum while the slide moves from side to side, a distance at which the slide moves increases with increase in semiconductor chip size. Also, the slide-type pickup apparatus is disadvantageous in terms of productivity due to the low speed of the slide.

### SUMMARY

Embodiments of the present invention provide a semiconductor chip pickup apparatus, which is suitable for separating a thin semiconductor chip from a die-bonding film without applying stress to the thin semiconductor chip.

According to an embodiment of the present invention, a thin semiconductor chip pickup apparatus for separating a semiconductor chip from a die-bonding film is provided. The apparatus includes a stage for supporting the die-bonding film, a plurality of suction members arranged on the center of the stage for extracting the die-bonding film by a vacuum, where the suction members detach the die-bonding film away from the semiconductor chip to form a vacuum region, and a plurality of vacuum suction ports respectively interposed between adjacent suction members to allow the suction members to extract the die-bonding film by the vacuum.

### BRIEF DESCRIPTION OF THE DRAWINGS

The above and other features and advantages of the present invention will become more apparent by describing in detail embodiments thereof with reference to the attached drawings in which:

FIG. 1 is a cross sectional view of a conventional needle-type semiconductor chip pickup apparatus;

FIG. 2 is a photograph illustrating a problem of the conventional semiconductor chip pickup apparatus;

FIG. 3A is a plan view illustrating a thin semiconductor chip pickup apparatus according to an embodiment of the present invention;

FIGS. 3B and 3C are plan views of the thin semiconductor chip pickup apparatus illustrated in FIG. 3A;

FIGS. 4A through 4D are cross sectional views illustrating a method of separating a semiconductor chip using the thin semiconductor chip pickup apparatus illustrated in FIG. 3A;

FIG. 5A is a plan view illustrating a thin semiconductor chip pickup apparatus according to another embodiment of the present invention;

FIG. 5B is a plan view of the thin semiconductor chip pickup apparatus illustrated in FIG. 5A; and

FIGS. 6A through 6C are cross sectional views illustrating a method of separating a semiconductor chip using the thin semiconductor chip pickup apparatus illustrated in FIG. 5A.

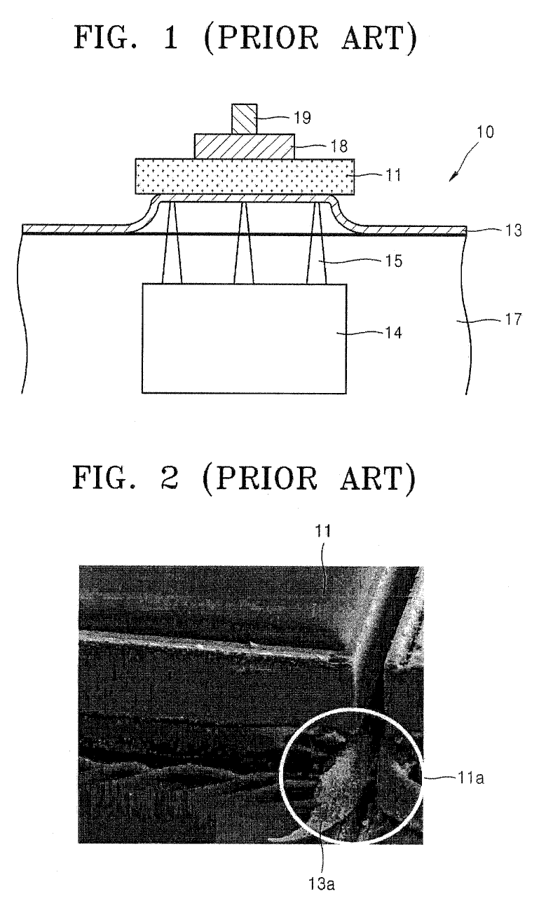

### DETAILED DESCRIPTION

The present invention will now be described more fully hereinafter with reference to the accompanying drawings, in which exemplary embodiments of the invention are shown. This invention may, however, be embodied in different forms and should not be construed as limited to the embodiments set forth herein. Rather, these embodiments are provided so that this disclosure is thorough and complete and fully conveys the scope of the invention to one skilled in the art. In the drawings, the thickness of layers and regions are exaggerated for clarity, and the same reference numerals are used to denote the same elements. Also, while relative directions and directional movements may be specified in a certain manner, these specified directions and directional movements are merely exemplary of one orientation of the elements. Thus, if in an apparatus one element is specified as being above the other element, the possibility that the element can be below the other element if the apparatus is turned over is considered. Likewise, if one element of the apparatus is disposed downward, the same element would be disposed upward if the apparatus was turned over. Hence, all orientations and directional movements are considered and the descriptions below should not be limited to any relative directions or directional movements specified in the embodiments below.

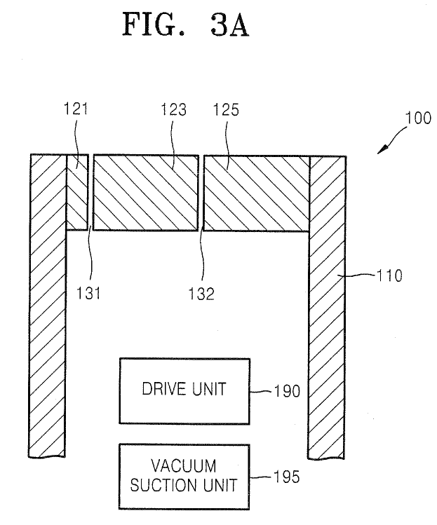

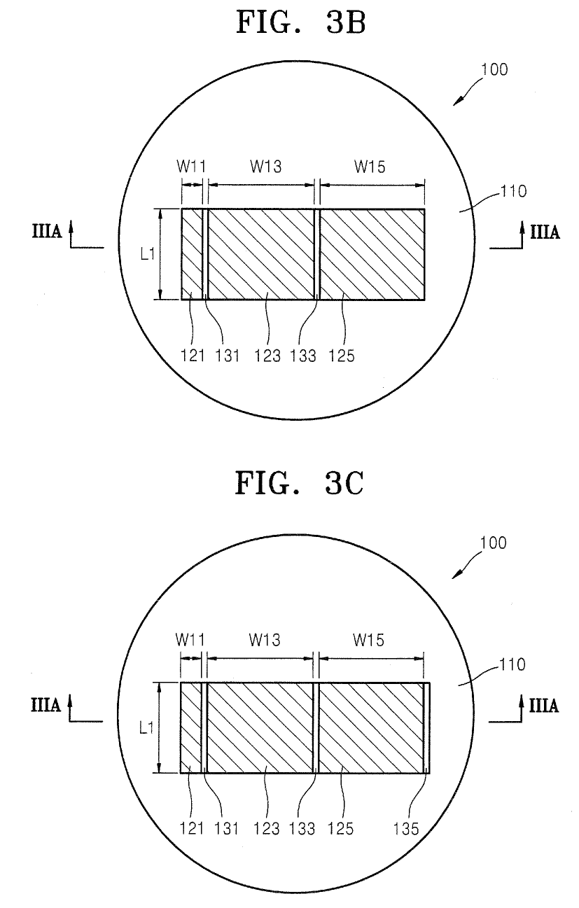

FIG. 3A is a plan view of a thin semiconductor chip pickup apparatus 100 according to an embodiment of the present invention, and FIGS. 3B and 3C are plan views of the thin semiconductor chip pickup apparatus illustrated in FIG. 3A. FIG. 3A is a cross sectional view taken along a line IIIA-IIIA of FIGS. 3B and 3C.

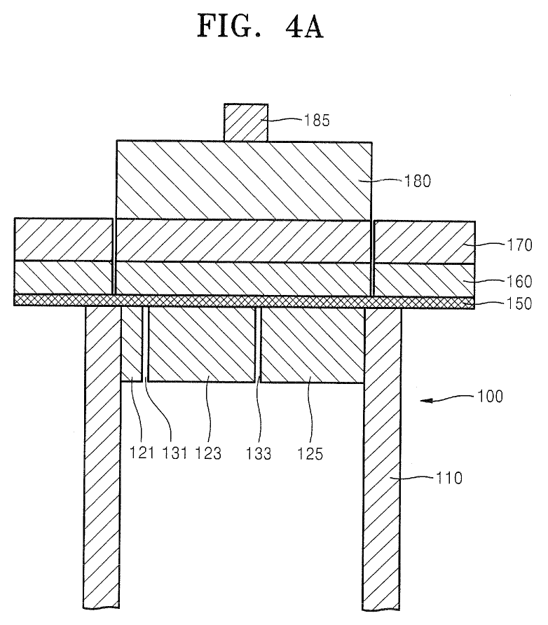

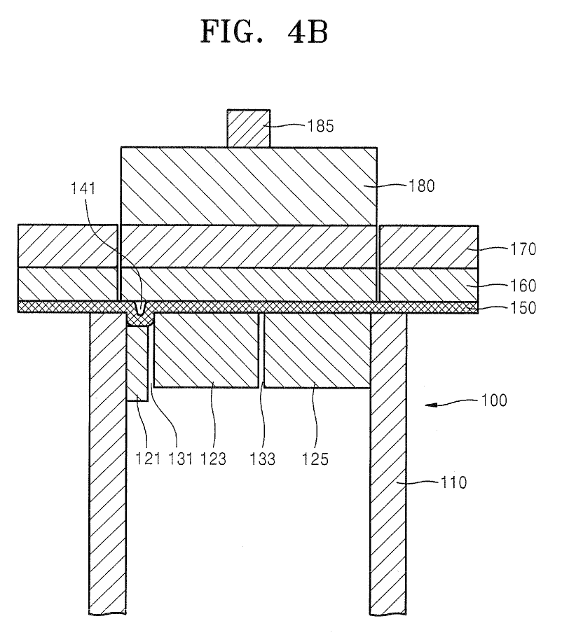

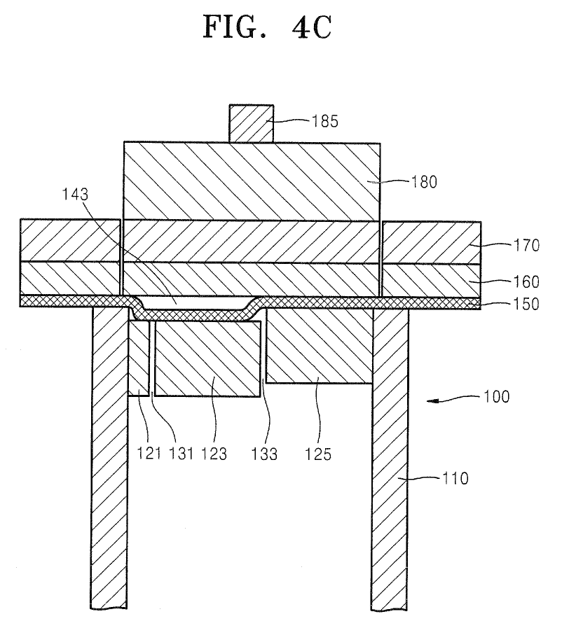

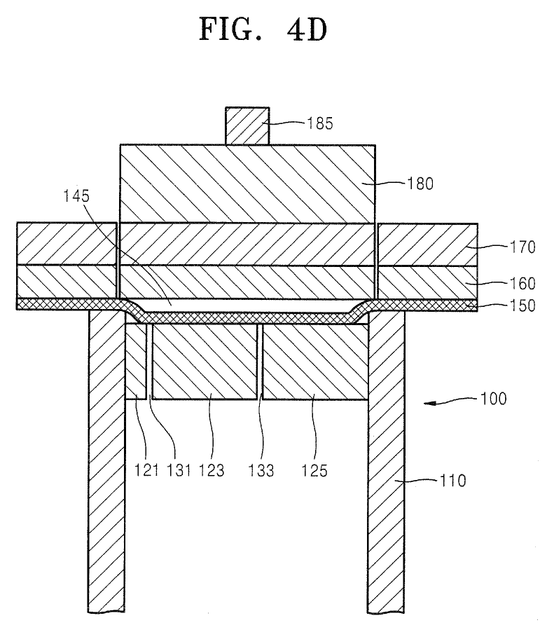

Referring to FIGS. 3A through 3C, the thin semiconductor chip pickup apparatus 100 includes a stage 110, which supports a die-bonding film 150 (Refer to FIG. 4A), a plurality of suction members 121, 123, and 125, which are arranged on the center of the stage 110 and extract the die-bonding film 150 by a vacuum, and a plurality of vacuum suction ports 131 and 133, which are respectively interposed between adjacent suction members 121, 123, and 125, (e.g., between 121 and 123, and between 123 and 125). A third vacuum suction port 135 may be further installed between the third suction member 125 and the stage 110. Also, a vacuum suction port (not shown) may be further installed between the first suction member 121 and the stage 110.

The first through third suction members 121, 123, and 125 may have different dimensions. Specifically, the first through third suction members 121, 123, and 125 may have the same length L1 and different widths W11, W13, and W15, respectively. A suction member arranged on an edge of a thin semiconductor chip 170 (refer to FIG. 4A) from among the first through third suction members 121, 123, and 125, for example, the first suction member 121, may have the first width W11 less than the second width W13 of the second suction member 123 or less than the third width W15 of the third suction member 125. For example, when the semiconductor chip 170 has a specific width and a length greater than the specific width, the length L1 of each of the first through third suction members 121, 123, and 125 may correspond to the width of the semiconductor chip 170, and the sum of the widths W11, W13, and W15 of the first through third suction members 121, 123, and 125 may correspond to the length of the semiconductor chip 170. The second width W13 of the second suction member 123 may be equal to or different from the third width W15 of the third suction member 125. The sum of the areas of the first through third suction members 121, 123, and 125 may be less than the area of the semiconductor chip 170 corresponding to the first through third suction members 121, 123, and 125. However, these dimensional relationships may vary in other embodiments.

The semiconductor chip pickup apparatus 100 further includes a drive unit 190 to move the first through third suction members 121, 123, and 125 up and down. Although not illustrated in the drawings, the drive unit 190 may include a motor so that the first through third suction members 121, 123, and 125 can move up and down using a conventional motor driving mechanism. Also, the semiconductor chip pickup apparatus 100 further includes a vacuum suction unit 195 to extract the die-bonding film 150 by a vacuum using the first through third vacuum suction ports 131, 133, and 135 during the movement of the first through third suction members 121, 123, and 125. Although not illustrated in the drawings, the vacuum suction unit 195 may include conventional vacuum suction equipment used in a semiconductor fabrication apparatus.

FIGS. 4A through 4D are cross sectional views illustrating a method of separating a thin semiconductor chip from a die-bonding film using the thin semiconductor chip pickup apparatus 100 illustrated in FIG. 3A. FIGS. 4A through 4D illustrates a method of sequentially separating the semiconductor chip from the die-bonding film in one direction from one side of the semiconductor chip to the other side of the semiconductor chip.

Referring to FIG. 4A, the die-bonding film 150 is attached to the semiconductor chip 170 using an adhesive 160 and is supported by the stage 110 of the semiconductor chip pickup apparatus 100. In this case, the die-bonding film 150 may be extracted by a vacuum generated using the first through third vacuum suction ports 131, 133, and 135 and the vacuum suction unit 195 while being supported by the stage 110. A pickup member, which includes a collet 180 and a transfer head 185, is disposed on the semiconductor chip 170. The collet 180 includes a vacuum suction pipe (not shown) to fix the semiconductor chip 170 by vacuum suction. The transfer head 185, which is fixed to the collet 180, moves up and down or from side to side and picks up the semiconductor chip 170.

Referring to FIG. 4B, the first suction member 121 of the first through third suction members 121, 123, and 125 is lowered by the drive unit 190 a specific distance downward or away from the semiconductor chip 170. The die-bonding film 150 is extracted downward or away from the semiconductor chip 170 by a vacuum using the first vacuum suction port 131. Thus, a first vacuum region 141 is formed in a position where the first suction member 121 moves away from the semiconductor chip 170, and a portion of the die-bonding film 150 corresponding to the first suction member 121 is detached from the semiconductor chip 170.

Referring to FIG. 4C, the second suction member 123 is lowered by the drive unit 190 a specific distance downward from the semiconductor chip 170, and the die-bonding film 150 is extracted downward or away from the semiconductor chip 170 by a vacuum using the vacuum suction unit 195 and the second vacuum suction port 133. In this case, the die-bonding film 150 may be extracted by a vacuum using the vacuum suction unit 195 and the first and second vacuum suction ports 131 and 133. As a result, a second vacuum region 143 is formed in a position where the second suction member 123 moves downward from the semiconductor chip 170, and a portion of the die-bonding film 150 corresponding to the second suction member 123 is also detached from the semiconductor chip 170.

Referring to FIG. 4D, the third suction member 125 is lowered by the drive unit 190 downward or away from the semiconductor chip 170, and the die-bonding film 150 is extracted downward or away from the semiconductor chip 170 by a vacuum using the vacuum suction unit 195, the second vacuum suction port 132, and the third vacuum suction port 135. In this case, the die-bonding film 150 may be extracted by a vacuum using the second vacuum suction port 133 and the third vacuum suction port 135. As a result, a third vacuum region 145 is formed in a position where the third suction member 125 moves downward from the semiconductor chip 170, and a portion of the die-bonding film 150 corresponding to the third suction member 125 is also detached from the semiconductor chip 170.

Since the four corners of the semiconductor chip 170 are generally more adhered to the die-bonding film 150 than other portions of the semiconductor chip 170, the first suction member 121, which is arranged to correspond to two corners of the four corners of the semiconductor chip 170, may be made less wide than the other suction members 123 and 125 so that portions of the die-bonding film 150 corresponding to the two corners of the semiconductor chip 170 can be detached from the semiconductor chip 170 earlier than other portions of the die-bonding film 150. Thereafter, the second and third suction members 123 and 125 are sequentially lowered to detach the other portions of the die-bonding film 150 from the semiconductor chip 170. Thus, the semiconductor chip 170 may be separated from the die-bonding film 170 without applying stress to the semiconductor chip 170. The pickup member detaches the semiconductor chip 170 from the die-bonding film 150 and mounts the semiconductor chip 170 on a printed circuit board (PCB) or a lead frame (not shown).

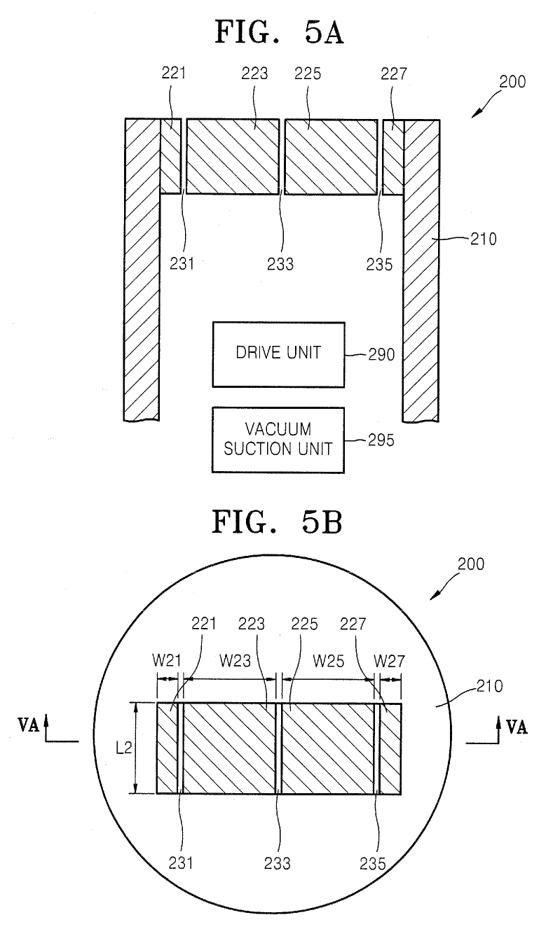

FIG. 5A is a plan view illustrating a thin semiconductor chip pickup apparatus 200 according to another embodiment of the present invention, and FIG. 5B is a plan view illustrating the thin semiconductor chip pickup apparatus 200 illustrated in FIG. 5A. FIG. 5A is a cross sectional view taken along a line IIIA-IIIA of FIG. 5B.

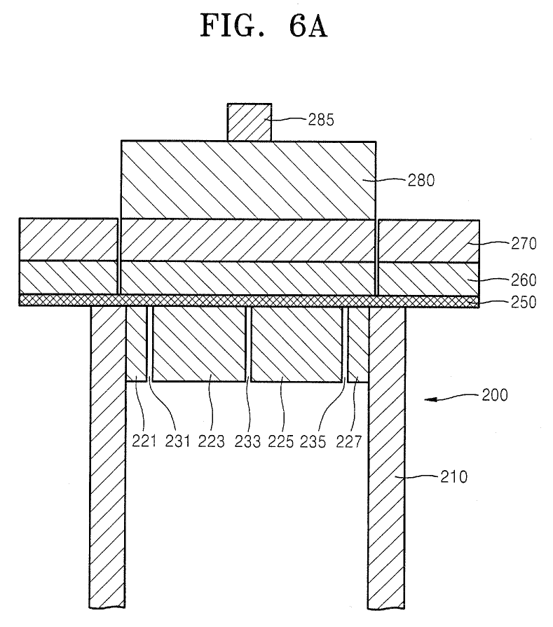

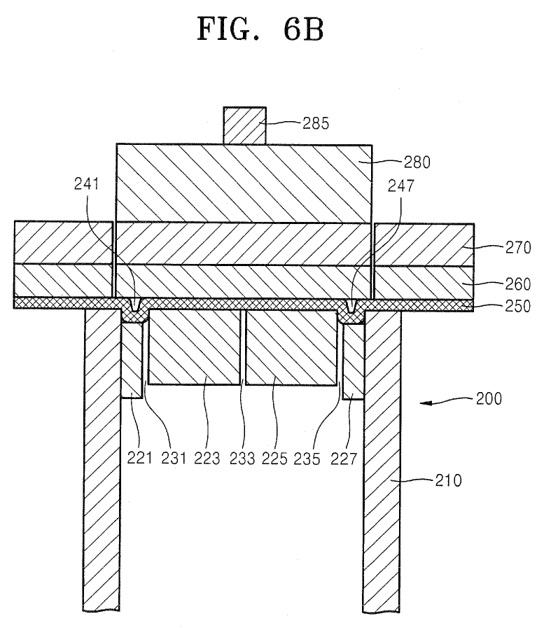

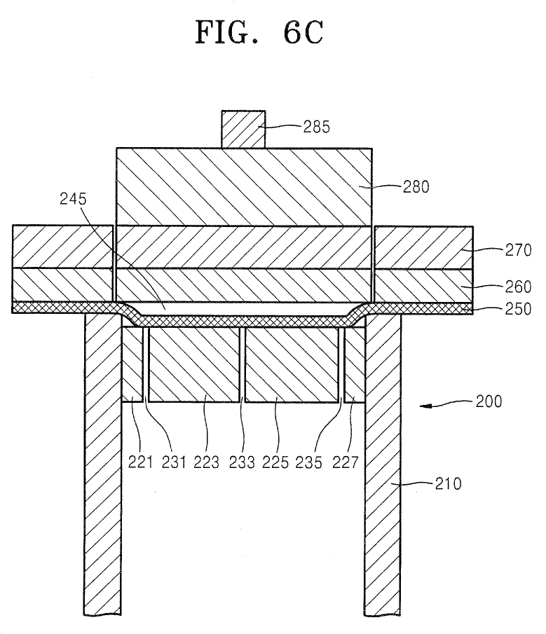

Referring to FIGS. 5A and 5B, the thin semiconductor chip pickup apparatus 200 includes a stage 210 for supporting a die-bonding film 250 (Refer to FIG. 6A), a plurality of suction members 221, 223, 225, and 227, which are arranged on the center of the stage 210 and extract the die-bonding film 250 by a vacuum, and a plurality of vacuum suction ports 231, 233, and 235, which are respectively interposed between adjacent suction members 221, 223, 225, and 227 (e.g., between 221 and 223, between 223 and 225, and between 225 and 227). Additional vacuum suction ports (not shown) may be further installed between the first suction member 221 and the stage 210 and between the fourth suction member 227 and the stage 210. The suction members 221, 223, 225, and 227 may have different dimensions than one another. Specifically, the first through fourth suction members 221, 223, 225, and 227 may have the same length L2 and different widths W21, W23, W25, and W27, respectively. Pairs of the suction members 221, 223, 225, and 227 may have substantially similar widths, and may be arranged so that the suction members 221 and 227 corresponding to the edges of the semiconductor chip 270 have substantially similar widths, and the suction members 223 and 225 corresponding to the central part of the semiconductor chip 270 may have substantially similar widths. Widths of the pair of suction members 223 and 225 corresponding to the central portion of the semiconductor chip 270 may be larger than the widths of the pair of suction members 221 and 227 corresponding to the edge portions of the semiconductor chip 270. For example, a pair of the suction members 221, 223, 225, and 227 that are arranged on both the edges of the semiconductor chip 270 (i.e., the first suction member 221 and the fourth suction member 227) may respectively have a first width W21 and a fourth width W27, where the first width W21 is substantially equal to the fourth width W27. Also, the first width W21 and the fourth width W27 of the first and fourth suction members 221 and 227 may be less than the width of the other pair of the suction members 221, 223, 225, and 227, namely, a second width W23 of the second member 223 and a third width W25 of the third suction member 225. In the present embodiment, the second width W23 of the second suction member 223 may be substantially equal to the third width W25 of the third suction member 225.

For instance, when the semiconductor chip 270 has a specific width and a length greater than the specific width, the length L2 of the first through fourth suction members 221, 223, 225, and 227 may correspond to the width of the semiconductor chip 270, and the sum of the widths W21, W23, W25, and W27 of the first through fourth suction members 221, 223, 225, and 227 may correspond to the length of the semiconductor chip 270. The sum of the areas of the first through fourth suction members 221, 223, 225, and 227 may be less than the area of the semiconductor chip 270 corresponding to the first through fourth suction members 221, 223, 225, and 227. However, these dimensional relationships may vary in other embodiments.

The semiconductor chip pickup apparatus 200 may further include a drive unit 290 to move the first through fourth suction members 221, 223, 225, and 227 up and down. Although not illustrated in the drawings, the drive unit 290 may include a motor so that the first through fourth suction members 221, 223, 225, and 227 can move up and down using a conventional motor driving mechanism. Also, the semiconductor chip pickup apparatus 200 further includes a vacuum suction unit 295 to extract the die-bonding film 250 by a vacuum using the first through fourth vacuum suction ports 231, 233, and 235 during the movement of the first through fourth suction members 221, 223, 225, and 227.

FIGS. 6A through 6C are cross sectional views illustrating a method of separating a semiconductor chip from a die-bonding film using the thin semiconductor chip pickup apparatus 200 illustrated in FIG. 5A. FIGS. 6A through 6C illustrate a method of sequentially separating the semiconductor chip from the die-bonding film in both directions of the semiconductor chip.

Referring to FIG. 6A, the die-bonding film 250 is attached to the semiconductor chip 270 using an adhesive 260 and is supported by the stage 210 of the semiconductor chip pickup apparatus 200. In this case, the die-bonding film 250 may be extracted by a vacuum using the vacuum suction unit 295 and the first through third vacuum suction ports 231, 233, and 235 while being supported by the stage 210. A pickup member, which includes a collet 280 and a transfer head 285, is disposed on the semiconductor chip 270 so that the semiconductor chip 270 is supported by the collet 280.

Referring to FIG. 6B, the first and fourth suction members 221 and 227 of the first through fourth suction members 221, 223, 225, 227 are lowered by the drive unit 290 a specific distance downward or away from the semiconductor chip 270. The die-bonding film 250 is extracted downward or away from the semiconductor chip 270 by a vacuum using the first and third vacuum suction ports 231 and 235. Thus, a first vacuum region 241 is formed in a position where the first suction member 221 moves downward, and a second vacuum region 247 is formed in a position where the fourth suction member 227 moves downward from the semiconductor chip 270. As a result, portions of the die-bonding film 250 corresponding to the first and fourth suction members 221 and 227 are detached from the semiconductor chip 270.

Referring to FIG. 6C, the second and third suction members 223 and 225 of the first through fourth suction members 221, 223, 225, and 227 are lowered by the drive unit 290 downward or away from the semiconductor chip 270, and the die-bonding film 250 is extracted downward or away from the semiconductor chip 270 by a vacuum using the vacuum suction unit 295 and the second vacuum suction port 233. In this case, the die-bonding film 250 may be extracted by a vacuum using the first through third vacuum suction ports 231, 233, and 235. As a result, a third vacuum region 245 is formed in a position where the second and third suction members 223 and 225 moves downward from the semiconductor chip 270, and a portion of the die-bonding film 250 corresponding to the second and third suction members 223 and 225 is also detached from the semiconductor chip 270.

One pair of the first through fourth suction members 221, 223, 225, and 227, for example, the first and fourth suction members 221 and 227, are arranged to each correspond to two corners of the four corners of the semiconductor chip 270, while the other pair of suction members, for example, the second and third suction members 223 and 225, are arranged to correspond to a central portion of the semiconductor chip 270. In this case, the first and fourth suction members 221 and 227 may have a smaller width than the second and third suction members 223 and 225 so that portions of the die-bonding film 250 corresponding the two corners of the semiconductor chip 270 can be detached from the semiconductor chip 270 earlier than other portions of the die-bonding film 250 in both directions. Thereafter, the second and third suction members 223 and 225 are simultaneously lowered to detach the other portions of the die-bonding film 250 from the semiconductor chip 270. Thus, the semiconductor chip 270 may be separated from the die-bonding film 270 without applying stress to the semiconductor chip 270. The pickup member detaches the semiconductor chip 270 from the die-bonding film 250 and mounts the semiconductor chip 270 on a PCB or a lead frame (not shown).

According to the embodiments of the present invention as described above, a die-bonding film is extracted by a vacuum using suction members so that a semiconductor chip can be detached from the die-bonding film. Therefore, a crack or break in the semiconductor chip due to stress can be prevented from occurring.

While the present invention has been particularly shown and described with reference to embodiments thereof, it will be understood by one of ordinary skill in the art that various changes in form and details may be made therein without departing from the spirit and scope of the present invention as defined by the following claims.

What is claimed is:

1. A thin semiconductor chip pickup apparatus for separating a semiconductor chip from a die-bonding film, the apparatus comprising:
a stage for supporting the die-bonding film;
a plurality of suction members arranged on a center of the stage for extracting the die-bonding film by a vacuum, the suction members configured to detach the die-bonding film away from the semiconductor chip; and
a plurality of vacuum suction ports configured to allow the suction members to detach the die-bonding film by the vacuum, wherein each vacuum suction port is interposed between adjacent suction members.

2. The apparatus of claim 1, wherein the suction members include:
a first suction member arranged to correspond to one edge of the semiconductor chip; and
a plurality of second suction members arranged to correspond to other potions of the semiconductor chip,
wherein the dimension of the first suction member is different from the dimensions of the second suction members.

3. The apparatus of claim 2, wherein the dimension of the first suction member is less than each of the dimensions of the second suction members.

4. The apparatus of claim 3, wherein the second suction members are of different dimensions.

5. The apparatus of claim 2, wherein the first suction member and the second suction members have substantially the same length, and the width of the first suction member is different from each of the widths of the second suction members.

6. The apparatus of claim 5, wherein the width of the first suction member is less than each of the widths of the second suction members.

7. The apparatus of claim 6, wherein the second suction members are of different widths.

8. The apparatus of claim 2, wherein the semiconductor chip has a first width and a first length greater than the first width, the first suction member and the second suction members have a length substantially equivalent to the first width of the semiconductor chip, and the sum of the widths of the first suction member and the second suction members is substantially equivalent to the first length of the semiconductor chip.

9. The apparatus of claim 1, wherein the suction members are arranged in pairs from both edges of the semiconductor chip to the center of the semiconductor chip, wherein a first pair of suction members arranged on both edges of the semiconductor chip has a dimension different from a second pair of suction members arranged on other portions of the semiconductor chip.

10. The apparatus of claim 9, wherein the first pair of suction members have dimensions less than dimensions of the second pair of suction members.

11. The apparatus of claim 10, wherein each of the first pair of suction members has substantially the same dimensions, and wherein each of the second pair of suction members has different dimensions.

12. The apparatus of claim 9, wherein the first pair of suction members has substantially the same lengths as the second pair of suction members and the widths of the first pair of suction members are different from the widths of the second pair of suction members.

13. The apparatus of claim 12, wherein the first pair of suction members each has a width smaller than a width of each of the second pair of suction members.

14. The apparatus of claim 13, wherein each of the first pair of suction members has substantially the same width, and wherein each of the second pair of suction members has a different width.

15. The apparatus of claim 9, wherein the semiconductor chip has a first width and a first length greater than the first width of the semiconductor chip, the suction members have a length substantially equivalent to the first width, and the sum of the widths of the suction members is substantially equivalent to the first length of the semiconductor chip.

16. A method of detaching a semiconductor chip from an attached die-bonding film using a thin semiconductor chip pickup apparatus, wherein the apparatus includes a stage for supporting the die-bonding film, a plurality of suction members arranged on the center of the stage, and a plurality of vacuum suction ports respectively interposed between adjacent suction members, the method comprising:
disposing a first suction member corresponding an edge of the semiconductor chip away from the semiconductor chip to detach a portion of the die-bonding film corresponding to the first suction member by a vacuum using a vacuum suction port adjacent to the first suction member to form a first vacuum region;
sequentially disposing second suction members corresponding to other portions of the semiconductor chip away from the semiconductor chip to sequentially detach portions of the die-bonding film corresponding to the disposed second suction members using the other vacuum suction ports to form a plurality of second vacuum regions; and
picking up the semiconductor chip from the die-bonding film by a pick up member.

17. The method of claim 16, wherein the first suction member has a different dimension from the second suction members.

18. The method of claim 17, wherein the first suction member is smaller than the second suction members, and the second suction members are of different dimensions.

19. The method of claim 16, wherein the first suction member has substantially the same length as the second suction members, and the first suction member has a width that is smaller than the width of each of the second suction members.

20. The method of claim 16, wherein the semiconductor chip has a first width and a first length greater than the first width, the first suction member and the second suction members have a length substantially equivalent to the first width of the semiconductor chip, and the sum of the widths of the first suction member and the second suction members is substantially equivalent to the first length of the semiconductor chip.

21. A method of detaching a semiconductor chip from an attached die-bonding film using a thin semiconductor chip pickup apparatus, wherein the apparatus includes a stage for supporting the die-bonding film, a plurality of suction members arranged on the center of the stage, and a plurality of vacuum suction ports respectively interposed between adjacent suction members, the method comprising:
disposing a first pair of suction members corresponding to opposing edge portions of the semiconductor chip away from the semiconductor chip to detach portions of the die-bonding film corresponding to the first pair of suction members by a vacuum using a pair of vacuum suction ports adjacent to the first pair of suction members to form a first vacuum region and a second vacuum region;
sequentially disposing a second pair of suction members corresponding to other portions of the semiconductor chip between the edge portions away from the semiconductor chip to sequentially detach portions of the die-bonding film corresponding to each of the second pair of suction members using a vacuum suction port adjacent to each of the second pair of suction members to form a third vacuum region; and
picking up the semiconductor chip from the die-bonding film by a pick up member.

22. The method of claim 21, wherein the first pair of suction members have different dimensions from the second pair of suction members.

23. The method of claim 22, wherein the first pair of suction members are smaller than the second pair of suction members.

24. The method of claim 23, wherein each of the first pair of suction members has substantially the same dimensions, and wherein each of the second pair of suction members has different dimensions.

25. The method of claim 21, wherein each pair of suction members has the same length, and wherein the first pair of suction members has a smaller width than the width of the second pair of suction members.

26. The method of claim 25, wherein each of the first pair of suction members has substantially the same width, and wherein each of the second pair of suction members has a different width.

27. The method of claim 21, wherein the semiconductor chip has a first width and a first length, each pair of suction members has a length substantially equivalent to the first width of the semiconductor chip, and the sum of the widths of the suction members is substantially equivalent to the first length of the semiconductor chip.
